(19) United States
(12) Patent Application Publication
(10) Pub. No.: US 2010/0164233 A1
(43) Pub. Date: Jul. 1, 2010

(54) Centrifugal torque amplifyer

(76) Inventors: Bobby Lewis Bates, Fallon, NV (US); Robert John Bates, Fallon, NV (US)

Correspondence Address: BOBBY L. BATES, 5575 ALCORN RD., FALLON, NV, 89406, US

(21) Appl. No.: 12/587,854

(22) Filed: Oct. 13, 2009

Related U.S. Application Data
(60) Provisional application No. 61/196,143, filed on Oct. 14, 2008.

(51) Int. Cl. H02K 7/18; F16F 15/30; F02N 11/08; G06F 19/00; H02K 47/04; H02K 53/00

(52) U.S. Cl. 290/1 R; 74/572.11; 290/48; 700/287; 310/113; 415/916

(57) ABSTRACT

Herein disclosed is an electrical power generation apparatus that produces more power than the apparatus consumes for operation and the excess power can be used for clean environmentally friendly energizing of additional devices of user choice. The overall apparatus is operational due to centrifugal force created within the assembly of the apparatus.

### CROSS REFERENCE TO RELATED APPLICATION

This application claims the benefit of U.S. Provisional Patent Application Ser. No. 61/196,143 filed Oct. 14, 2008 by the present inventors.

### FIELD OF THE INVENTION

This invention relates in general to an apparatus that produces more energy than it requires for operation and the excess energy is usable as an electrical power source. More particularly the apparatus produces the energy utilizing centrifugal force in a new and novel manner. The apparatus includes standard components that are easily assembled which in combination form a structure including a free-floating rotational swing arm with adjustable weights. More importantly the apparatus is initially powered by a simple battery(s). Whereby, the apparatus can be utilized and installed at any remote location of choice, it is environmentally friendly, extremely efficient and economically cost effective to,produce, sell and operate.

### BACKGROUND OF THE INVENTION

Within the known prior art there are numerous attempts to produce alternative energy sources as there is a great need for improvement on existing power alternatives. Currently the majority of electricity is produced from heat engines in which the working substance is steam that is generated from combustion of fossil fuels or from nuclear fission. Other types of power generation include hydroelectric power and/or wind assemblies of which are somewhat feasible but are either not environmentally friendly or economical to operate.

Still further examples of power generation include various types of machines that convert mechanical energy into electrical energy. For example, U.S. Pat. No. 7,095,126 entitled “INTERNAL ENERGY GENERATING POWER SOURCE” is somewhat functional as it utilizes standard electrical components but it does not include mechanical torque amplification which now proves to be most advantageous. Other attempts to harness excess energy from mechanical generation include U.S. Pat. Nos. 7,226,378, 4,889,013, 4,907,474, 7,105,939 and 2,266,594. Each of which are somewhat functional for their intended use but each are much too complicated, are only operative with magnets respectively and require many parts of which the present invention eliminates.

Most importantly none of these cited references recognize, utilize and/or incorporate the natural properties of centrifugal force which is most advantageous. There are very few inventions within the known prior art that utilize centrifugal energy. For exemplary purposes centrifugal energy is utilized within U.S. Pat. Nos. 4,590,813 and 4,498,357, however due to their construction they do not effectively harness enough energy from the centrifugal force. Thus, these references are again simply not feasible as they are much too complicated and do not achieve the new and unusual results of which are clearly achieved by the present invention.

It is therefore contended that there is a great need for improvement within the field of alternative energy. Especially, a simple economical self contained and self energized environmentally friendly apparatus for production of energy such as the present invention.

### SUMMARY OF THE INVENTION

It is therefore an object of the present invention to provide a new and novel apparatus for clean production of energy without the need for fossil fuels or any other type of pollutant source.

It is another object of the present invention to provide an energy source that generates more energy than the energy source requires for operation.

Yet another object of the present invention is to provide an electric power generating apparatus that requires only a battery(s) for initial start-up.

Still a further object of the present invention is to provide an electric power generating apparatus that can be easily installed and erected at any location of choice and may be produced as a mobile portable unit, depending on engineering choice.

A further object of the present invention is to provide an electric power generating apparatus that produces enough energy to operate itself as well as providing enough excess energy to power other devices electrically interconnected thereto.

A most important object of the present invention is to provide an electric power generating apparatus that is self sufficient due to centrifugal force of which is not to be confused with perpetual motion. Centrifugal force is hypothetically defined as an apparent force that seems to pull a rotating or spinning object away from a center. Perpetual energy is hypothetically defined as continuous operation of a mechanism without the introduction of energy from an external source, known as perpetual motion of the first kind. A device demonstrating this would violate the first law of thermodynamics, which states that energy can neither be created nor destroyed.

Still a further object of the present invention is to provide an electric power generating apparatus that is easily constructed from pre-existing components and does not require any specialized tools and/or equipment other than those currently available within the field.

Yet another object of the present invention is to provide an electric power generating apparatus that is controllable, adjustable and the operational perimeters may manually be regulated and/or computer operated/controlled depending on engineering preferences.

Other objects and advantages will become apparent when taken into consideration with the following drawings and specification.

### BRIEF DESCRIPTION OF THE DRAWINGS

FIG. 1 is a general block diagram illustrating the conceptual operational components and functional perimeters for the present invention.

FIG. 2 is a general block diagram illustrating the conceptual operation components of which may be monitored and/or operated by a computer control system.

FIG. 3 is a frontal overview of a scaffolding structure for support of the main components for the present invention.

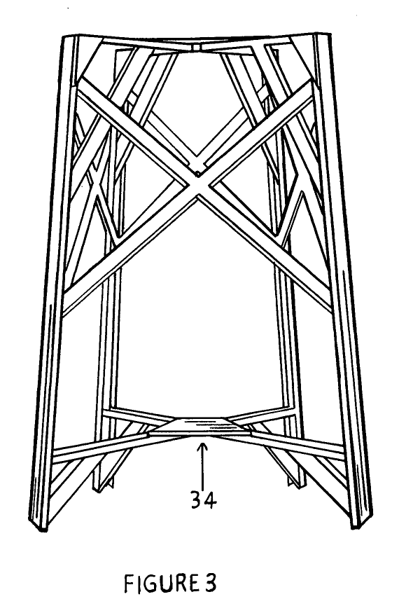

FIG. 4 is a frontal overview illustrating the main components for the centrifugal torque amplification assembly for the present invention.

### DETAILED DESCRIPTION OF THE DRAWINGS

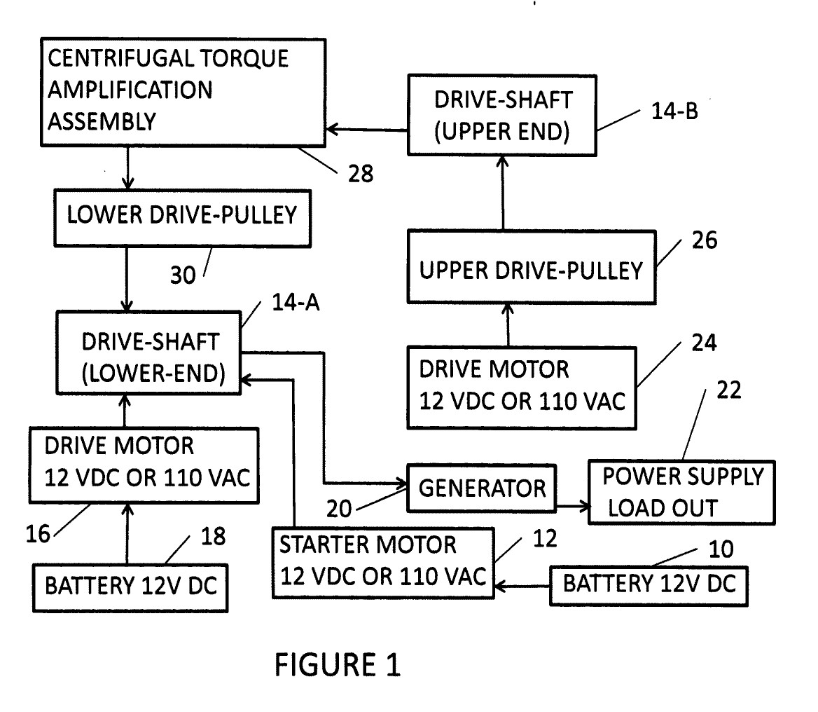

Referring now in detail to the drawings wherein like elements refer to like numerals throughout the various views. As depicted in FIG. 1, (10) represents a first battery. It is to be noted any suitable battery of engineering choice may be incorporated, but for illustrative purposes a standard off the shelf 12V DC battery is most functional. Also it is to be noted the battery may be solar powered if desired. The battery (10) is in electrical communication with a starter motor (12). The starter motor can also be any suitable type of engineering choice such as a standard 12 VDC or 110 VAC or the like. The starter motor (12) is in electrical mechanical communication with the lower-end (14-A) of a drive shaft assembly. Whereby, upon initial start-up, the battery (10) energizes starter motor (12) which in turn via mechanical/electrical communication causes the drive shaft assembly to rotate substantially at a fixed 1800 RPM rate. The lower-end (14-A) of the drive shaft is further in electrical mechanical communication with a first drive motor (16) which is in electrical mechanical communication with a second battery (18). Whereby, the second battery and the first drive motor cooperate together to further control the rotation of the drive shaft to enhance centrifugal force during intermittent moments of lag due to extra drawn horsepower. The lower end (14-A) of the drive shaft is further in electrical/mechanical communication with a generator (20) of which is used for production of electricity “power supply load out (22)” that is used to power numerous devices of user choice, such as household appliances or the like. The apparatus further includes a second drive motor (24) which is in electrical/mechanical communication with an upper drive pulley (26) of which is interconnected onto the upper end of the drive shaft (14-B) of which is interconnected in mechanical communication onto the centrifugal torque amplification assembly (28) and the lower end of the drive shaft (14-A) is mechanical communication and interconnected onto the centrifugal torque amplification assembly (28) via a lower drive pulley 30. It can now be seen the general concept for the components and how they are mechanically/electrically interconnected is illustrated in FIG. 1. It is to be noted this general overview is only exemplary of one possible configuration as variables are inherent and the invention is not to be limited to these components nor their interaction.

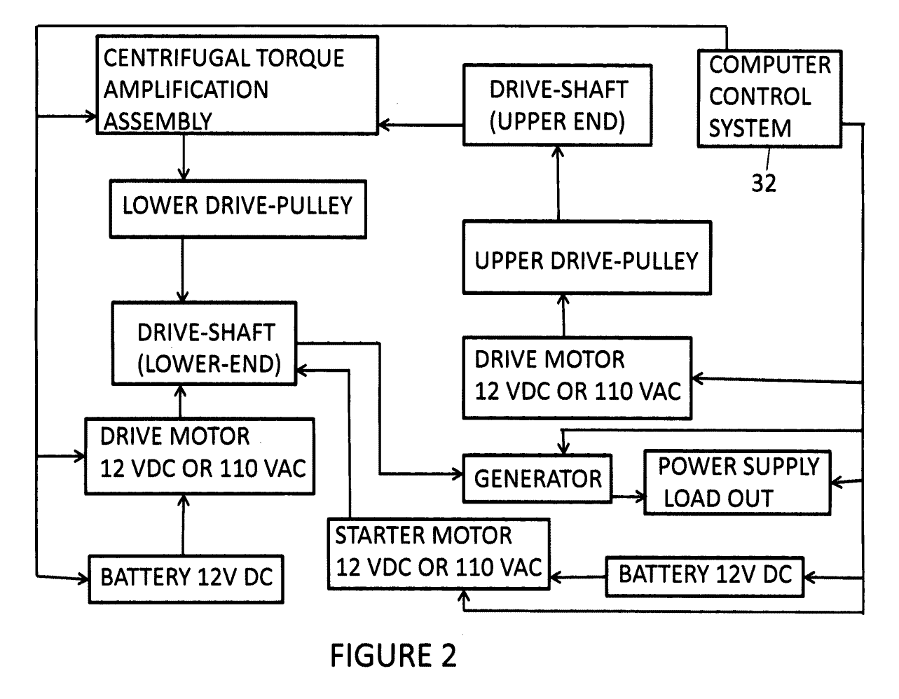

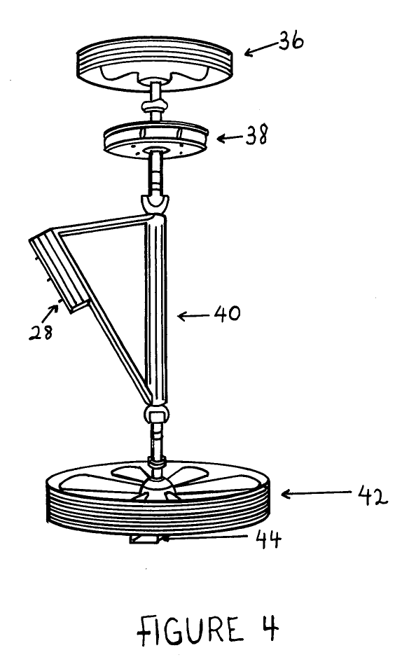

Referring now to FIG. 2, wherein as illustrated the overall apparatus can be monitored and/or controlled via a computer control system (32) if desired. Whereby the computer control system (32) can be electrically interconnected onto the main components and all of the functional parameters can be recorded and/or regulated accordingly. It is to be noted the motors, generator, batteries, software and/or computer specifications are not taught herein as this technology is pre-existing and need not be claimed herein. Furthermore, all of the components are to be supported and arranged within their respective positions within a suitable scaffolding structure (34) as illustrated within FIG. 4. It is to be understood this scaffolding structure (34) is only exemplary of one possible configuration or embodiment and the invention is not to be limited thereto as numerous variations are inherent.

It is to be further understood that the overall new and unusual results of the present invention are attributed to the construction of the centrifugal torque amplification assembly (28) as illustrated in FIG. 4. Wherein the assembly substantially includes a supply feed (36) which is constructed according to engineering choice. For example, the supply feed may be assembled from a 2″ case hardened steel shaft, a 36″×5½″ 5 band-pulley 3600-1800 RPM, the ⅓ horsepower low torque drive motor 110/12 volt and a mounting brace. All of which when assembled form the upper supply feed (36) of which is interconnected onto the supply feed/dual drive plates (38) which is constructed from a 24″×¾″ adjustable plate, 12″×3″×4″ spacer blocks and 7″×½ bolts respectively. The supply feed/dual drive plates (38) are interconnected onto the central centrifugal drive assembly (40) which is respectively constructed from a 3¼″ shaft, U-Joints, a 48″ swing arm, a 26″ shoulder brace, an 18″×3″×2″ counter weight and suitable coupling adapter of which are interconnected with the generator output (42). The generator output (42) includes a 2500 Watt generator 25 KVA, A 46″×15″ adjustable generator bracket, a 51″×4 ½ 4 band pulley: 3600-1800 RPM, a 24″×24″×¾″ Plate with weld and 5 ½″ pillar bearing with two 7″×½″ bolts; grease-zerks, etc. All of which are interconnected with the Booster Drive Assembly 44. The Booster Drive Assembly 44 includes a 11″×½″ flywheel, a ½ horsepower booster motor, a 16″×1½″×6″ adjustable booster bracket, a 4″ 9/16 double washer shear pin bolt, a 6″×½″ anchor bolt, 2½″ welded coupling and a 5″ singular flange welded spacer. All of which in combination allow for the centrifugal torque amplification assembly (28) to create the desired centrifugal force of which can then be harnessed and converted to electricity for the useable energy source of user and/or engineering choice.

It can now be seen in general the overall apparatus is created from a rotating free float drive line with adjustable weights placed in a vertical position and connects to the upper dual plates that rotate at a fixed 1800 RPM rate, respectively. The duel plates connect to an upper pulley and varying horsepower motor with a 2″ shaft, this creates an internal spin with amplified centrifugal force that enhances horsepower. A booster motor is placed at the bottom of the floating shaft to enhance centrifugal force in the intermittent moments of lag due to extra drawn horsepower. In operation, the centrifugal force amplifies the output of the horsepower input. The input motor is a stage motor that runs on a 110 volt ac OR 12 BOLT dc, with a ⅓, ½ or ¾ single phase motor. ⅓ at 110 bolt AC start-up is at 8 amps; ½ 10 amps; and ¾ 12 amps. The start-up pulleys begin the spinning motion of the shaft, powered by batteries, rechargeable through solar panels. Once the shaft begins to rotate and picks up momentum to create centrifugal force, the motion runs the generator at three times its horsepower capability. Brakes can be applied to the top pulley to slow down the motion, and a smaller 12 bolt booster motor has been added to the bottom to counteract drag.

Although the invention has been herein shown and described in what is conceived to be the most practical and preferred embodiment, it is recognized that departures may be made there from within the scope and spirit of the invention, which is not to be limited to the details disclosed herein but is to be accorded the full scope of the claims so as to embrace any and all equivalent devices and apparatuses.

1. A centrifugal torque amplifier comprising: a centrifugal torque amplification assembly; a first battery; a second battery; a starter motor; a first drive motor; a second drive motor; a drive shaft assembly; and a generator; said drive shaft assembly having an upper end and a lower end; said first battery is in electrical communication with said starter motor, said first starter motor is in electrical mechanical communication with said lower end of said drive shaft assembly, upon initial start up, said first battery energizes said starter motor which in turn via mechanical electrical communication causes said drive shaft assembly to rotate at a fixed RPM rate, said lower end of said drive shaft assembly is further in electrical mechanical communication with said second drive motor which is in electrical mechanical communication with said second battery, whereby, said second battery and said second drive motor cooperate together to further control the rotation of said drive shaft assembly to enhance centrifugal force during intermittent moments of lag due to extra drawn horsepower, said lower end of said drive shaft assembly is further in electrical mechanical communication with said generator of which is used for production of electricity, said second drive motor is in electrical mechanical communication with an upper drive pulley of which is interconnected onto said upper end of said drive shaft assembly of which is interconnected in mechanical communication onto said centrifugal torque amplification assembly and said lower end of said drive shaft assembly is in mechanical communication and interconnected onto said centrifugal torque amplification assembly via a lower drive pulley.

2. The centrifugal torque amplifier of claim 1 wherein said first battery and/or said second battery is a standard 12V DC or a standard solar power variety.

3. The centrifugal torque amplifier of claim 1 wherein said starter motor is a standard 12 VDC OR 110 VAC.

4. The centrifugal torque amplifier of claim 1 wherein said first drive motor and/or said second drive motor is a standard 12 VDC OR 110 VAC.

5. The centrifugal torque amplifier of claim 1 wherein said fixed RPM rate is 1800.

6. The centrifugal torque amplifier of claim 1 is monitored and/or controlled via a computer control system, whereby said computer control system is electrically interconnected onto the main components and all of the functional parameters can be recorded and/or regulated accordingly.

7. The centrifugal torque amplifier of claim 1 further includes a scaffolding structure wherein all of the components are to be supported and arranged within their respective positions within said scaffolding structure.

8. The centrifugal torque amplifier of claim 1 wherein said centrifugal torque amplification assembly includes a supply feed; supply feed/dual drive plates; a central centrifugal drive assembly; and a booster drive assembly.

9. The centrifugal torque amplifier of claim 8 wherein said supply feed is assembled from a hardened steel shaft, a band-pulley, a low torque drive motor and a mounting brace, all of which when assembled form said supply feed, said supply feed is interconnected onto said supply feed/dual drive plates, said supply fee/dual drive plates are constructed from an adjustable plate, spacer blocks and bolts, said supply feed/dual drive plates are interconnected onto said central centrifugal drive assembly, said central centrifugal drive assembly is constructed from a shaft, U-Joints, a swing arm, a shoulder brace, a counter weight and a coupling adapter of which are interconnected with the generator output, whereby in combination allow for said centrifugal torque amplification assembly to create the desired centrifugal force of which can then be harnessed and converted to electricity for the useable energy source of choice.
